(19) United States
(12) Patent Application Publication
(10) Pub. No.: US 2004/0151132 A1
(43) Pub. Date: Aug. 5, 2004

(54) Method of and apparatus for communication, communication control system, and computer product

(75) Inventors: Yoshiki Terashima, Kanagawa (JP); Keiichi Teramoto, Kanagawa (JP); Yuzo Tamada, Kanagawa (JP); Tomohiro Hiruma, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/747,123

(22) Filed: Dec. 30, 2003

(30) Foreign Application Priority Data
Jan. 21, 2003 (JP) 2003-011842

(51) Int. Cl. H04B 7/005

(52) U.S. Cl. 370/278; 370/449

(57) ABSTRACT

A communication apparatus, which communicates with a host unit based on polling method, includes a control receiving unit that receives a control information to be transferred to the host unit from a user terminal, a request receiving unit that receives a request from the host unit to transfer the control information to the host unit, and a transmitting unit that transfers the control information to the host unit as a response to the request, provided that the control receiving unit receives the control information after the request receiving unit receives the request.

### CROSS-REFERENCE TO RELATED APPLICATIONS

This application is based upon and claims the benefit of priority from the prior Japanese Patent Applications No. 2003-011842 filed on Jan. 21, 2003; the entire contents of which are incorporated herein by reference.

### BACKGROUND OF THE INVENTION

1) Field of the Invention

The present invention relates to a communication apparatus, and more particularly, to a communication apparatus that receives a request for information from a host unit and transmits the information to the host unit based on polling method.

2) Description of the Related Art

As electric appliances become a part of a network, it is now possible to make a remote control of the electric appliances through the network. Various types of control methods are currently in use, however, an attention is paid to a control method based on Hyper Text Transfer Protocol (HTTP) by a Web server from a point of a versatility and ease of implementation.

A conventional control method places a Web server in the same intranet that an equipment to be controlled is installed. To control the equipment from a remote location, it is necessary to allow the server in the intranet to be connected from the remote location. This necessitates an access point having an address that enables an access from the remote location. Since the HTTP is a well known protocol, such an access point is prone to be subjected to an illegal act like a mischievous access from malice, thereby causing a problem of security.

To cope with the problem, a conventional polling method (hereinafter, “polling”) is employed instead of installing an access point in the same intranet. In polling communication, another server is disposed in the external network to check a request, and the another server confirms if there is an operation request from a communication apparatus in the intranet.

However, in the method involving confirmation, communication is necessary for every confirmation. If the confirmation is performed frequently during short period of time to process a control request that is assigned to make a good response, the communication cost for this confirmation becomes extremely high.

It is an object of the present invention to provide a method of and an apparatus for communication, a communication control system, and a computer product that assure a response to a control request without increasing the cost of communication by using polling that ensures security.

### SUMMARY OF THE INVENTION

It is an object of the present invention to solve at least the problems in the conventional technology.

The communication apparatus for communicating with a host system according to one aspect of the present invention includes a request receiving unit configured to receive requests from the host system, each request requesting to transmit a control information relating to a user terminal, a control receiving unit configured to be waiting to receive an information at least including a control information from the user terminal after receiving the request from the host system, and a transmitting unit configured to transmit a response to the host system after the control receiving unit receives the information from the user terminal, the response including at least the control information received from the user terminal.

The communication control system according to another aspect of the present invention includes a host unit configured to transmit a request for receiving control information, a communication apparatus configured to transmit the control information corresponding to the request as a response to the request, and a user terminal configured to transmit the control information to the communication apparatus. The user terminal includes a control inputting unit for inputting a control information, and a control transmitting unit configured to transmit the control information to the communication apparatus. The host unit includes a request transmitting unit configured to transmit a request for receiving the control information to the communication apparatus, and a response receiving unit configured to receive the control information as a response to the request from the communication apparatus. The communication apparatus includes a request receiving unit configured to receive requests from the host unit, each request requesting to transmit a control information relating to the user terminal, a control receiving unit configured to be waiting to receive an information at least including the control information from the user terminal after receiving the request from the host unit, and a transmitting unit configured to transmit the response to the host unit after the control receiving unit receives the information from the user terminal.

The method of communication according to still another aspect of the present invention, which is employed in a communication control system that includes a user terminal, a communication apparatus, and a host unit, includes the communication apparatus receiving a request from the host unit, each request requesting to transmit a control information relating to the user terminal, the communication apparatus waiting to receive a information from a user terminal, the information including at least the control information to be transferred to the host unit, and the communication apparatus transmitting the control information to the host unit as a response to the request after receiving the request.

The computer program according to still another aspect of the present invention, which is employed in a communication control system that includes a user terminal, a communication apparatus, and a host unit, makes a computer and the communication apparatus execute the method according to the present invention.

### BRIEF DESCRIPTION OF THE DRAWINGS

FIG. 1 is a schematic diagram of a communication control system according to a first embodiment of the present invention;

FIG. 2 is a block diagram of a communication apparatus according to the first embodiment;

FIG. 3 is a block diagram of an ASP server according to the first embodiment;

FIG. 4 is a flow chart of communication control in the communication control system according to the first embodiment;

FIG. 5 is a schematic diagram of the communication control system according to a second embodiment of the present invention;

FIG. 6 is a block diagram of the ASP server according to the second embodiment;

FIG. 7 is a flow chart of a process for determining response time that is measured by a timer of the ASP server in the communication control system according to the second embodiment;

FIG. 8 is a flow chart of communication control in the communication control system according to the second embodiment;

FIG. 9 is a flow chart of detailed processing by the ASP server in the communication control shown in FIG. 8;

FIG. 10 is a schematic diagram of the communication control system according to a modification of the first embodiment; and

FIG. 11 is a block diagram of an electric appliance according to the modification.

### DETAILED DESCRIPTION

Exemplary embodiments of a communication apparatus, a communication control system, a method of communication according to the present invention is described in detail with reference to the accompanying drawings. However, it is to be noted that the invention is not limited by the embodiments.

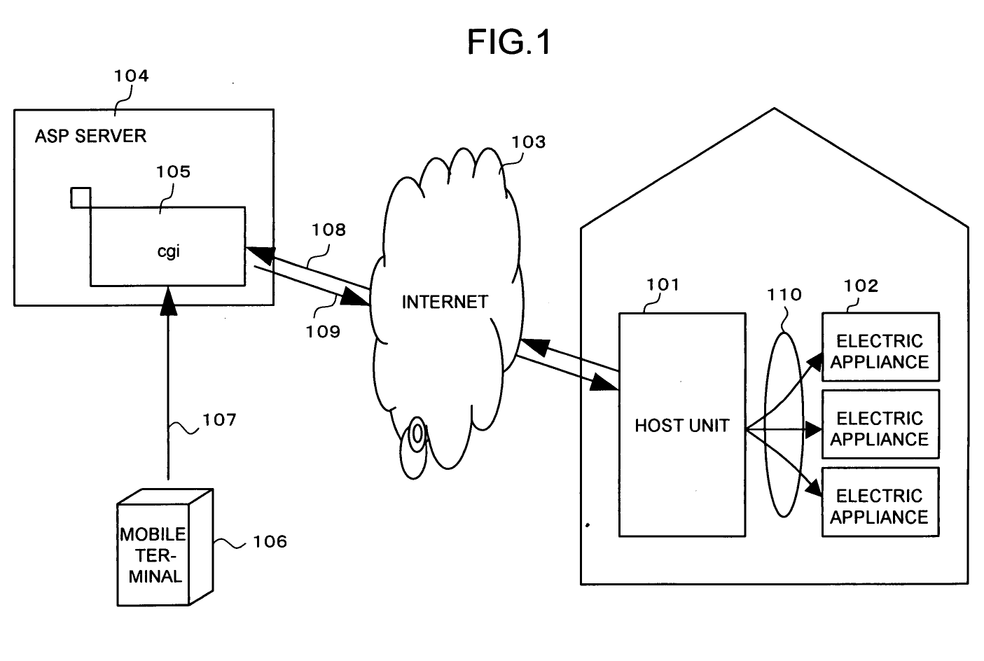

FIG. 1 a schematic diagram of a communication control system according to the first embodiment of the present invention. The communication control system includes a mobile terminal 106, an Application Service Provider (ASP) 104, a host unit 101, and an electric appliance 102. According to the communication control system, a user that is away from a location where the electric appliance 102 is installed, can control the electric appliance by using the mobile terminal 106.

The host unit 101 communicates with the ASP server 104 through Internet 103 and with the electric appliance 102 through a network 110 in the location of installation. The host unit 101 receives a control signal from the ASP server 104 for control of the electric appliance 102 and controls the electric appliance 102 according to the control signal. The control signal for example, is a signal that instructs putting ON of power supply of a television (TV). Thus, the control signal is an instruction for a predetermined electric appliance. The control signal according to the present embodiment is a control information in the present invention.

Moreover Bluetooth (a trade mark) that is used in short distance wireless communication is used as the network 110. The other examples that may be used as the network 110 are IEEE 802.11 of wireless Local Area Network (LAN) standard, Infrared Data Association (IrDA) of infrared communication standard, wired LAN that is in conformity with either Ethernet (R) or IEEE 1394. Furthermore, the network 110 may have wireless LAN and wired LAN intermingled. Thus, the network 110 is not restricted to the one that is mentioned according to the present embodiment.

The electric appliance 102 may be a TV, a video, an air conditioner, and a refrigerator. The electric appliance 102 receives the control signal from the host Unit 101 through the network 110 and is operated based on the control signal. In concrete terms, when the control signal that instructs to put the power supply of the TV ON is received, the power supply of the TV is switched ON.

On the other hand, the mobile terminal 106 is a portable terminal that can be used in a location away from the location of installation and receives input from a user. The user inputs information that instructs the control of the electric appliance 102. Concretely the mobile terminal 106 may be a Personal Digital Assistance (PDA), a mobile Personal Computer (PC), or a mobile telephone.

The ASP server 104 is a Web server that is open to users on Internet 103 for providing a service of application software through Internet.

The ASP server 104 includes a Common Gateway Interface (CGI) 105. The CGI 105 is a program that is started (executed) by a Web server function of the ASP server 104. The CGI 105 executes the program when the ASP server 104 receives an HTTP request 108 from the host unit 101 and returns the result of processing performed by the program to the host unit 101 as an HTTP response 109.

In this case, the HTTP request 108 includes information of a request for reception of HTTP that includes the control signal input by the user in the mobile terminal 106. The HTTP response 109 includes command information that is assigned by the control signal 107 to an electric appliance.

The CGI 105 is not necessarily a program and may be a hardware having an equivalent function.

Thus, in q1, the HTTP transmits control information indicating instruction that is input by the user in the mobile terminal 106 to the host unit 101 through the ASP server 104. The host unit 101 controls the electric appliance 102 based on the control information that is received.

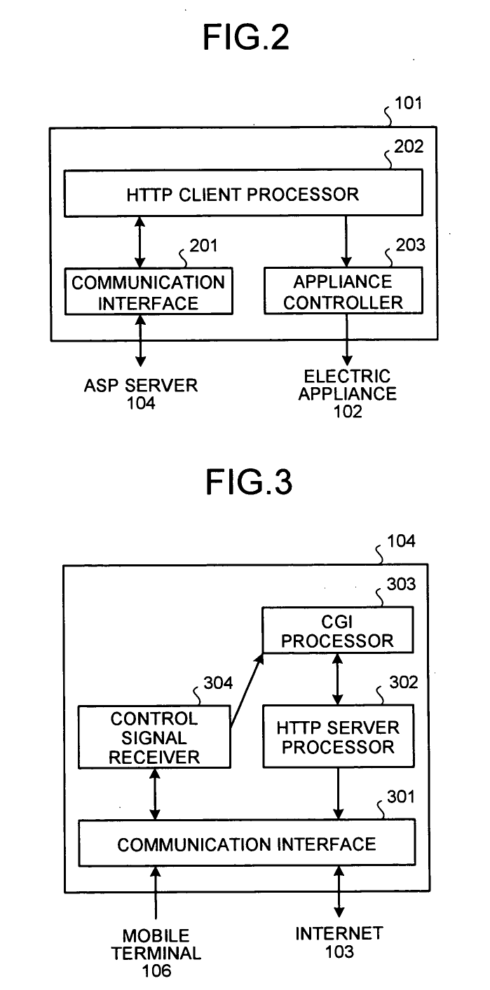

FIG. 2 is a block diagram of the host unit 101 according to the present embodiment. The host unit 101 includes a communication interface 201, an HTTP client processor 202, and an appliance controller 203.

The communication interface 201 communicates by polling communication with the ASP server 104 through the Internet 103. The communication interface 201 is a connection interface with subscriber's loop like Integrated Services Digital Network (ISDN), Asymmetric Digital Subscriber Line (ADSL) etc.

The HTTP client processor 202 transmits the HTTP request 108 to the ASP server 104 through the communication interface 201 and receives the HTTP response 109 as a response to the HTTP request 108 through the communication interface 201. In other words, according to the present embodiment, the host unit 101 transmits and receives a reception request by polling communication and a reply to the reception request conforming to HTTP. The HTTP client processor 202 extracts the command information from the HTTP response 109, edits the command information, and transmits it to an appliance controller 203.

The appliance controller 203 accepts the control signal 107 as command information from the HTTP client processor 202 and transmits the control signal 107 to the electric appliance 102 through the network 110. The appliance controller 203 further converts the control signal 107 such that it can be interpreted by the electric appliance 102 that is to be controlled and transmits the converted information to the electric appliance 102.

FIG. 3 is a block diagram of the ASP server 104 according to the present embodiment. The ASP server 104 includes a communication interface 301, an HTTP server processor 302, a CGI processor 303, and a control signal receiver 304. The ASP server 104 according to the present embodiment is a communication apparatus of the present invention.

The communication interface 301 communicates with the mobile terminal 106. The communication interface 301 also communicates with the host unit 101 through the Internet 103. The communication method between the communication interface 301 and the mobile terminal 106 and the communication method between the communication interface 301 and the host unit 101 may be the same. The communication method may be a method like Transmission Control Protocol/Internet Protocol (TCP/IP). As another example, the communication method between the communication interface 301 and the mobile terminal 106 and the communication method between the communication interface 301 and the communication apparatus may be different.

It is desirable that the communication interface 301 communicates with the communication apparatus conforming to HTTP. It is also desirable that the communication interface communicates with the mobile terminal 106 conforming to HTTP. In this case, the communication interface 301 would employ the same communication method as that employed by the mobile terminal 106 and it is not restricted to the present embodiment only.

In another example, a protocol converter may be provided between the mobile terminal 106 and the ASP server 104. In such case, the communication interface 301 converts a protocol to a communication method that can be interpreted by the communication interface 301.

The HTTP server processor 302 accepts the HTTP request through the communication interface 301. The HTTP server processor 302 transmits information that is necessary to execute a CGI program that is involved in the HTTP request 108, to the CGI processor 303. The HTTP server processor 302, then accepts result of execution of the CGI program from the CGI processor 303 and generates the HTTP response 109 that includes the result of execution of the program.

The control signal receiver 304 accepts the control signal 107 from the mobile terminal 106 through the communication interface 301. The control signal receiver 304 analyzes the content of the control signal 107, edits the control signal 107 based on the analysis, and transmits the edited information to the CGI processor 303.

The CGI processor 303 starts executing the CGI program that is specified by the HTTP request 108 that is received by the HTTP server processor 302. The CGI processor 303 executes the program by using the control signal 107 that is accepted from the control signal receiver and transmits the result of execution to the HTTP server processor 302.

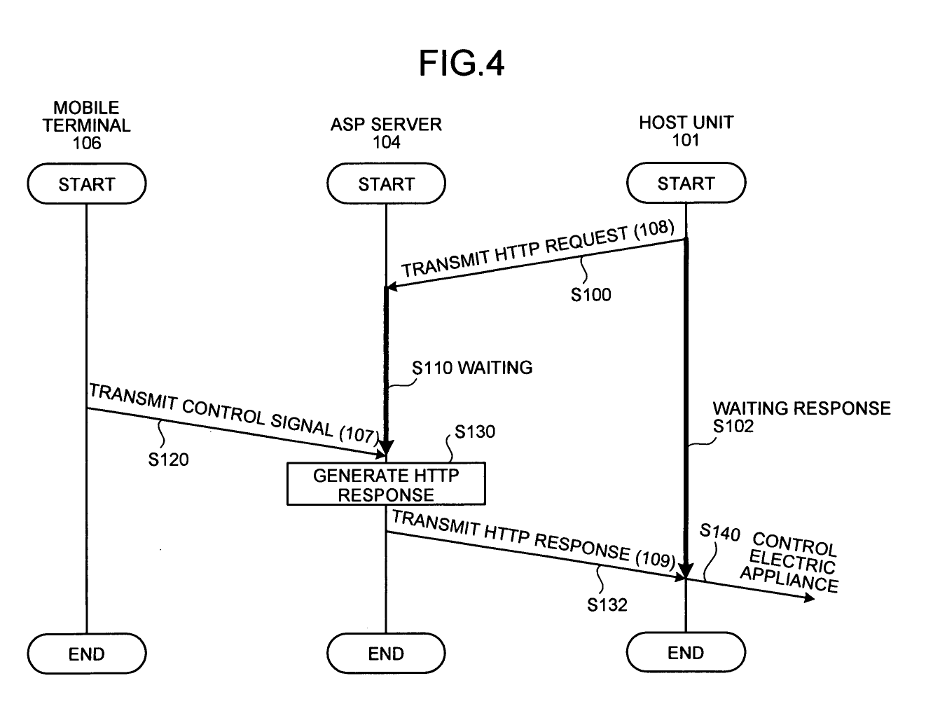

FIG. 4 is a flow chart of communication control in the communication control system according to the present embodiment. The host unit 101 receives a control signal that controls the electric appliance 102 and transmits the HTTP request 108 to the ASP server 104 (step S100). The host unit 101, then waits for the HTTP response 109 from the ASP server 104 (step S102). In other words, the communication apparatus waits for the response.

On the other hand, as the ASP server 104 receives the HTTP request 108, it waits for the control signal 107 from the mobile terminal 106 (step S110). In other words, the ASP server waits for the response.

The CGI program includes processing that makes the ASP server 104 wait after receiving of the HTTP request 108 and releases the APS server 104 from waiting after receiving of the control signal from the CGI 105.

The ASP server 104 is made to wait by continuing the execution of the CGI program by the CGI processor 303 according to the instructions from the HTTP server processor 302 in the ASP server 104.

Furthermore, when the mobile terminal 106 receives input of the control signal 107 from the user, it transmits the control signal 107 to the APS server 104 (step S120).

When the communication interface 301 of the APS server 104 receives the control signal 107, the HTTP server processor 302 and the CGI processor 303 generate the HTTP response 109 based on the control signal 107 (step S130). The communication interface 301 then transmits the HTTP response 109 to the host unit 101 through the Internet 103.

When the communication interface 301 transmits the HTTP response 109, the ASP server 104 is released from waiting. Thus, the series of processes of the ASP server 104 ends.

When the communication interface 201 of the host unit 101 receives the HTTP response 109, the ASP server 104 is released from waiting and the appliance controller 203 controls the electric appliance 102 based on the control signal 107 that is included in the HTTP response 109. Thus, the communication control in the communication control system ends.

In this way, in the communication control system according to the present embodiment, the host unit 101 is equivalent to the host unit in the communication control method by polling communication. Therefore, the host unit 101 cannot be accessed illegally and the security of the network in the location where the equipment is installed is ensured.

Furthermore, by employing the communication control method of polling communication, the increase in cost including the increase in traffic caused during communication for confirmation from the location where the equipment is installed to the other location, can be reduced.

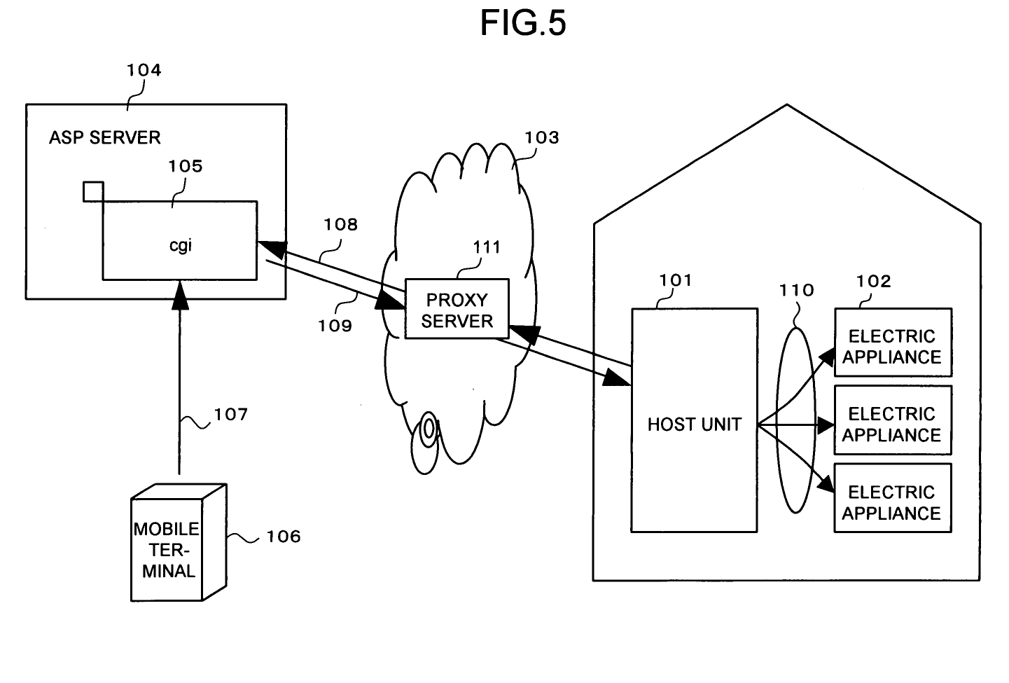

FIG. 5 is a schematic diagram of the communication control system according to the second embodiment of the present invention. The communication control system in the second embodiment further includes a proxy server 111. Concretely, the proxy server 111 receives an HTTP request that is transmitted from the host unit 101 as an HTTP client to the ASP server 104 as a Web server and transfers the HTTP request to the destination, i.e. ASP server 104. The proxy server 111 receives a response to the HTTP request from the ASP server 104 and transfers it to the host unit 101 that transmitted the HTTP request.

Moreover, a firewall function may be included in the proxy server 111. The firewall function prevents an access from outside to the network 110 including the HTTP client.

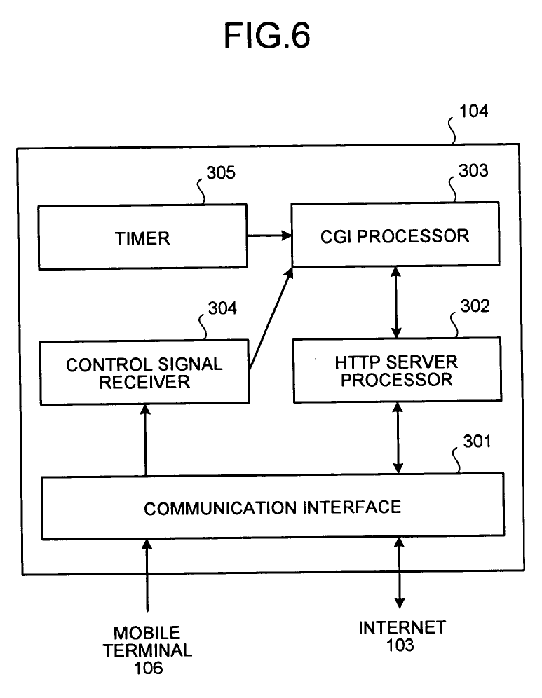

FIG. 6 is a block diagram of the ASP server 104 according to the second embodiment. The ASP server 104 in the second embodiment includes a timer 305 in addition to the functional structure of the ASP server 104 in the first embodiment. Thus, the ASP server 104 in the second embodiment differs from the ASP server in the first embodiment.

The timer 305 measures time. When the timer 305 measures a response time that is predetermined, it outputs a signal to the CGI processor 303.

When the CGI processor 303 receives the signal from the timer 305, the CGI processor 303, in cooperation with the HTTP server processor 302 generates a temporary HTTP response that does not include the control signal 107. Then, the communication interface 301 transmits the temporary HTTP response to the host unit 101 through the proxy server 111.

The timer 305, the HTTP server processor 302, and the CGI processor 303 according to the present embodiment form a timer of the present invention.

In a normal proxy server, after transmitting an HTTP request to the Web server, if there is no response in a specific fixed time, the connection is disconnected (hereinafter “time-out”). This is to avoid connection in a case where the HTTP client doesn't receive the HTTP request after the request is transmitted or in a case where the Web server does not transmit a response to HTTP due to some reason.

In the communication control system according to the present embodiment, the time of transmission of the control signal 107 or the time till the transmission of the control signal 107 by the mobile terminal 106 can not be predicted. Therefore, the proxy server 111 sometimes makes a judgment of time-out and disconnects the connection even if the ASP server 104 is waiting.

On the other hand, if the proxy server 111 is structured such that it doesn't perform time-out, even the unnecessary connection cannot be disconnected. The unnecessary connection occupies the communication source of the Web server or the proxy server and sometimes there is even a risk of not being able to perform the communication.

For this reason, the ASP server 104 in the second embodiment transmits the temporary HTTP response whenever the timer 305 measures a predetermined time. Therefore, the proxy server 111 cannot make a judgment of time-out even if the ASP server 104 is waiting, thereby enabling to avoid disconnecting of connections that are necessary.

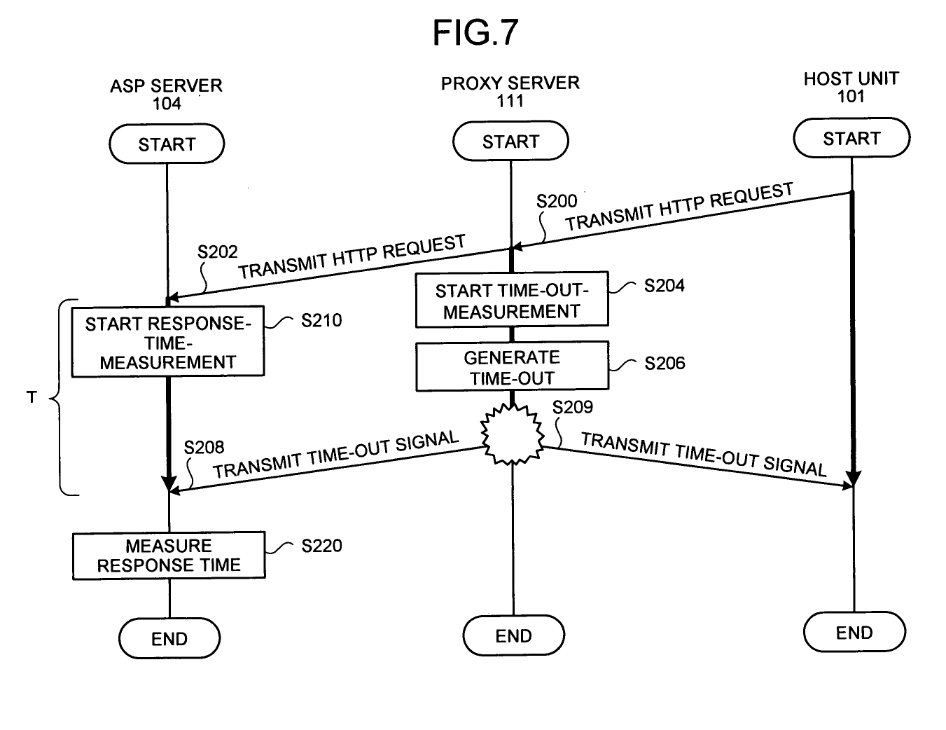

FIG. 7 is a flow chart of a process for determining response time that is measured by a timer 305 of the ASP server 104. To start with, the host unit 101 transmits an HTTP request to the ASP server 104 through the proxy server 111 (step S200 and step S202). Then the host unit 101 and the proxy server 111 wait for a response to the request.

Here, since the HTTP request is transmitted to receive a reception request by the polling communication, it need not be necessarily the information that requests a control signal.

The ASP server 104 starts measuring the time T when it receives the HTTP request (step S210). On the other hand, when the proxy server 111 transfers the HTTP request that is received from the host unit 101 to the ASP server 104, it starts measuring the time (step S204) and continues measuring till the time-out that is fixed in advance.

Further, when the proxy server 111 measures the time-out time that is fixed in advance without receiving the response to the HTTP request from the ASP server 104, it makes a judgment of generation of time-out (step S206). Then, the proxy server 111 transmits a time-out signal to the ASP server 104 and the host unit 101 (step S208 and step S209). The proxy server then disconnects the connection with the ASP server 104 and releases the ASP server from waiting. Similarly, it disconnects the connection with the host unit 101 and releases it from waiting.

When the ASP server 104 receives the time-out signal, it determines the response time based on the time T measured at this point of time (step S220). Concretely, the ASP server determines the response time as shorter than the measured time T by Δt (response time is T−Δt).

Here, the timer 305 forms a time-out measuring unit and a time interval calculating unit of the present invention.

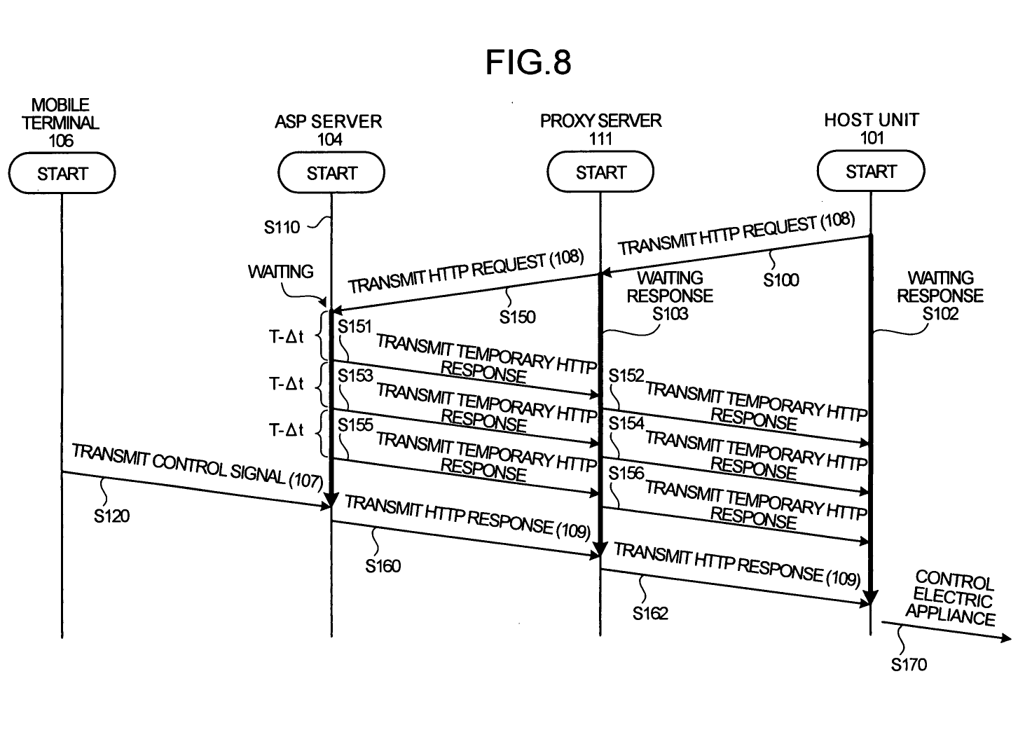

FIG. 8 is a flow chart of communication control in the communication control system in the second embodiment. To start with, the host unit 101 transmits an HTTP request 108 to the ASP server 104 through the proxy server 111 (step S100, and step S150). After having transmitted the HTTP request, the host unit 101 waits for a response to the HTTP request 108 from the ASP server 104 through the proxy server 111. The proxy server 111 also waits for the response to the HTTP request 108 from the ASP server 104.

On the other hand, in the ASP server 104, when the communication interface 301 receives the HTTP request 108, the timer 305 starts measuring the response time. In this case, the response time that is measured by the timer 305 is the time determined by a procedure that is described by referring to FIG. 7.

Whenever the response time is over, the communication interface 301 transmits a temporary HTTP response that does not include the control signal 107 to the host unit 101 through the proxy server 111 (step S151 and step S152). The ASP server repeats the transmission of the temporary HTTP response till receiving of the control signal 107 from the mobile terminal 106 (step S153 and step S156).

The temporary HTTP response can not include information that indicates end of a series of communication conforming to HTTP. For this reason, the proxy server 111 can avoid disconnecting of the connection by making a judgment of end of the communication even if the temporary HTTP response is received.

Further, when the communication interface 301 receives the control signal 107 from the mobile terminal 106 (step S120), it transmits an HTTP response 109 that is generated based on the control signal 107 to the host unit 101 through the proxy server 111 (step S160 and step S162). In this case, the HTTP response 109 includes information that indicates end of a series of communication conforming to HTTP. The host unit 101 then controls the electric appliance based on the HTTP response. Thus, the communication control of the communication control system ends.

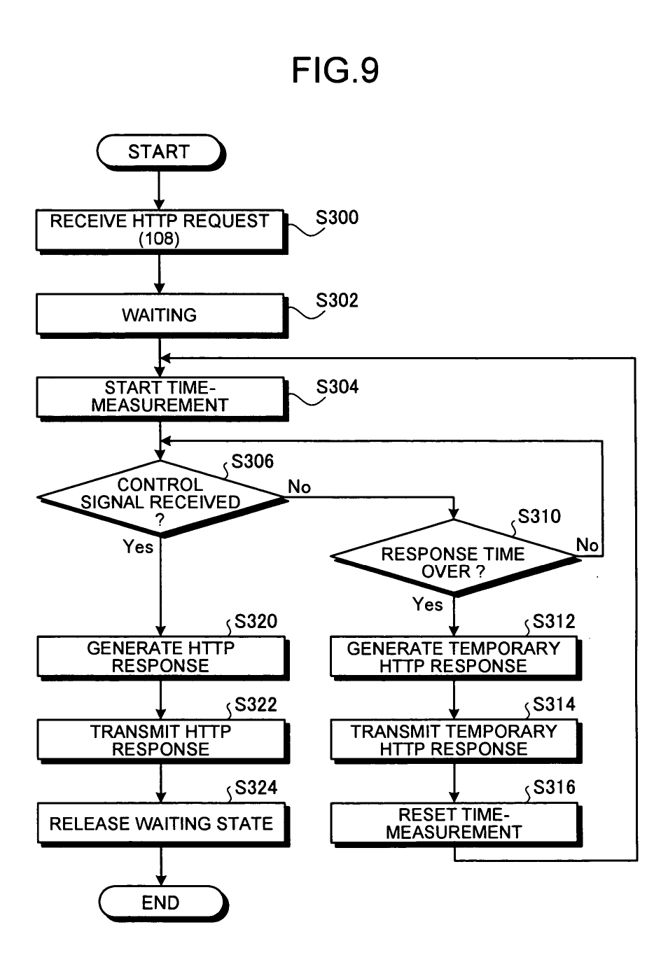

FIG. 9 is a flow chart of detailed processing by the ASP server 104 in the communication control that is described in FIG. 8.

When the communication interface 301 of the ASP server 104 receives an HTTP request 108 from the communication unit 101 through the proxy server 111 (step S300), it waits for an HTTP response 109 (step S302). The timer 305 then starts measuring the time (step S304).

After this, if the response time gets over before the communication interface 301 receives the control signal 107 from the mobile terminal 106 (step S306, No, step S310, Yes), the HTTP server processor 302 in cooperation with the CGI processor 303 generates a temporary HTTP response that does not include the control signal 107 (step S312). The communication interface 301 transmits the temporary HTTP response to the host unit 101 through the proxy server 111 (step S314). The timer 305 resets the measurement of time (step S316), returns to step S304, and starts the time measurement from zero.

On the other hand, when the communication interface 301 receives the control signal 107 from the ASP server 104 (step S306, Yes), the HTTP server processor 302 in cooperation with the CGI server 303 generates an HTTP response 109 based on a control signal 107 (step S320). The communication interface 301 transmits the HTTP response 109 to the host unit 101 through the proxy server 111 (step S322). The ASP server 104 is released from waiting (step S324). Thus, the process of the ASP server 104 ends.

In this way, according to the communication control system in the second embodiment, without incorporating any change in the proxy server 111, the judgment of time-out is made and rejection of receiving of the HTTP response can be avoided in this proxy server 111. Thus, even in a network environment including an unspecified proxy server and even after the elapsing of predetermined time after the ASP server 104 accepts a reception request by polling communication, the control signal 107 can be transmitted to the host unit 101 as a response by polling communication.

The present invention is explained by using the embodiments and further effects and modifications can be lead easily by a person having ordinary skill in the art. The embodiments of the present invention are not restricted only to the specified embodiments described above. Various modifications can be done in the scope within the general idea in accompanied claims of the inventions and their equivalent.

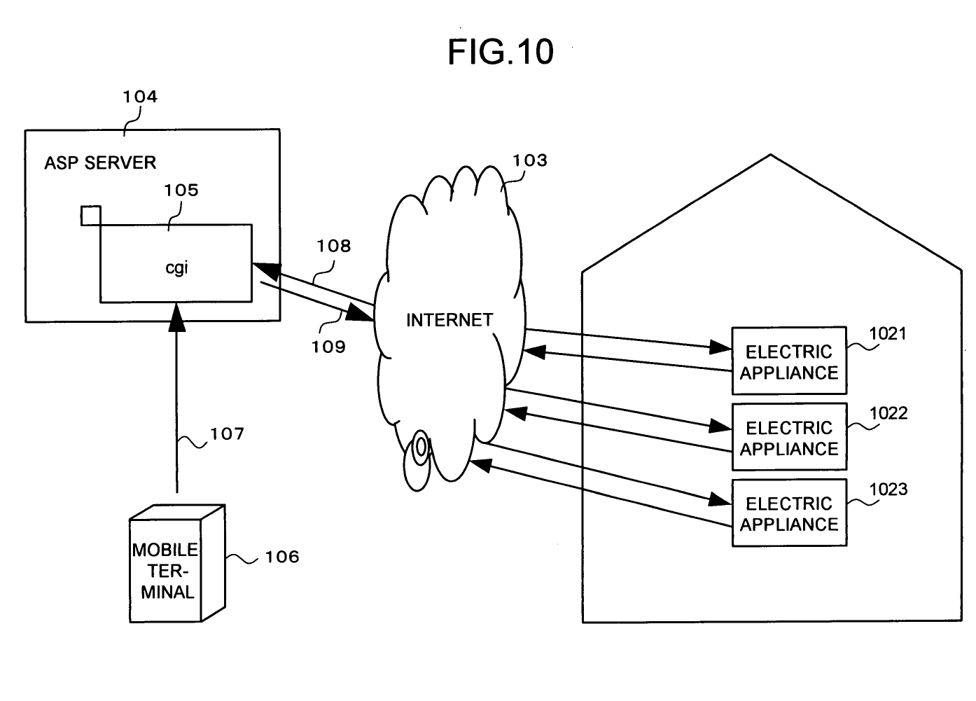

As a first modification, the electric appliance 102 may be provided with a similar function as that of the host unit 101 in the embodiment. FIG. 10 is a schematic diagram of the communication control system according to a modification of the first embodiment.

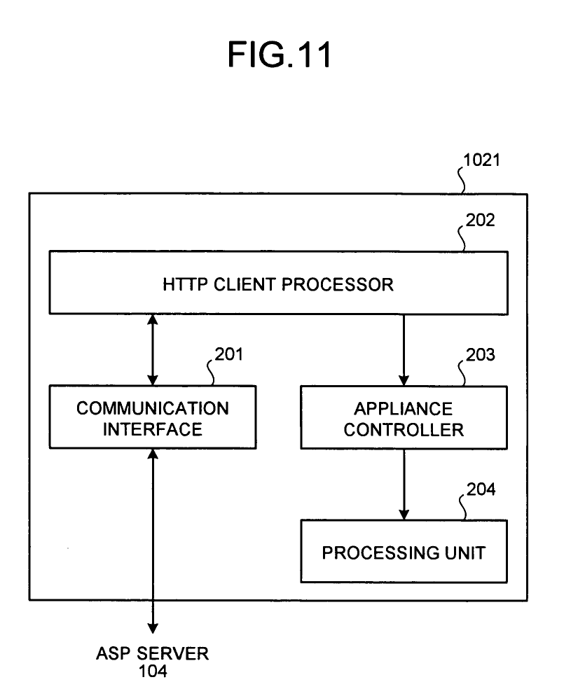

In this example, each of electric appliances 1021, 1022, and 1023 are provided with a structure similar to that of the host unit 101 described in the first embodiment. FIG. 11 is a block diagram of an electric appliance 1021 according to the modification. The electric appliance 1021 includes a processor 204 in addition to the functional structure of the host unit 101 in the first embodiment. The processor 204 performs processing based on instructions from an appliance controller 203. Concretely, the processor 204 performs processing such as putting the power supply ON and OFF.

Other structure and processing in the communication control system in this example is similar to those in the communication control system in the first embodiment.

Processing in a case of receiving of one HTTP request 108 by the ASP server 104 is described in the first and the second embodiments. As a second modification, a plurality of q 108 may be received before end of processing of the one HTTP request 108. In this case, an independent communication control process is performed for each of the HTTP request 108. Thus, even if the ASP server 104 communicates with a plurality of communication apparatuses 101, the HTTP requests 108 from the ASP server 104 can be processed concurrently.

In the embodiments, HTTP is employed for communication between the host unit 101 and the ASP server 104. As a third modification, Hyper Text Transfer Protocol Security (HTTPS) may be used instead of HTTP. By using HTTPS, security can be improved as compared to that by using HTTP, by avoiding intercepting of communication contents by a third party.

On the other hand, if the processing to ensure security is to be performed every time whenever the control request is confirmed, the load consumed for the processing is considerable. However, in the host unit 101 and the ASP server 104 according to the present embodiment, the processing to ensure security may be performed only at the first connection conforming to HTTPS. Thus, the load consumed for such processing can be reduced.

In the embodiments, the HTTP response 109 included the control signal 107. As a fourth modification, the HTTP response 109 may not include the control signal 107. In this case, the HTTP response 109 functions as a signal to release the host unit 101 from waiting. When the communication apparatus is released from waiting, the information of the control signal 107 that is stored in the ASP server 104 may be acquired separately. Moreover, as another example, other predetermined processing may be started as the host unit 101 is released from waiting.

As a fifth modification, each function of the host unit 101 and the ASP server 104 can be performed by a computer. This enables to have a program that executes the functions equivalent to those of the host unit 101 and the ASP server 104.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus for communicating with a host system, comprising:
a request receiving unit configured to receive requests from the host system, each request requesting to transmit a control information relating to a user terminal;
a control receiving unit configured to be waiting to receive an information at least including a control information from the user terminal after receiving the request from the host system; and
a transmitting unit configured to transmit a response to the host system after the control receiving unit receives the information from the user terminal, the response including at least the control information received from the user terminal.

2. The communication apparatus according to claim 1, further comprising a timer that generates a trigger at a predetermined time interval after the request receiving unit received the request, wherein the transmitting unit transmits a predetermined information as the response to the host system whenever the timer generates the trigger, and the predetermined information does not include an information on an end of transmission of the response to the host system.

3. The communication apparatus according to claim 2, upon the control receiving unit receiving the control information, the transmitting unit transmits the control information with the information on end of transmission of the response to the host unit as the response to the request.

4. The communication apparatus according to claim 2, further comprising:
a time-out measuring unit configured to measure a time from the request receiving unit receiving the request to the request receiving unit receiving time-out information indicating that there is no response to the request; and
an interval calculating unit configured to calculate, based on the time measured by the time-out measuring unit, a time interval at which the timer generates the trigger, wherein the timer generates the trigger at the time interval calculated by the interval calculating unit.

5. The communication apparatus according to claim 4, wherein the interval calculating unit sets the time interval shorter than the time that is measured by the time-out measuring unit.

6. The communication apparatus according to claim 1, wherein the transmitting unit transmits the response based on either of Hyper Text Transfer Protocol and Hyper Text Transfer Protocol Security.

7. The communication apparatus according to claim 1, wherein the request receiving unit receives the request based on either of Hyper Text Transfer Protocol and Hyper Text Transfer Protocol Security.

8. A communication control system comprising:
a host unit configured to transmit a request for receiving control information;
a communication apparatus configured to transmit the control information corresponding to the request as a response to the request; and
a user terminal configured to transmit the control information to the communication apparatus, wherein
the user terminal includes
a control inputting unit for inputting a control information; and
a control transmitting unit configured to transmit the control information to the communication apparatus,
the host unit includes
a request transmitting unit configured to transmit a request for receiving the control information to the communication apparatus; and
a response receiving unit configured to receive the control information as a response to the request from the communication apparatus, and
the communication apparatus includes
a request receiving unit configured to receive requests from the host unit, each request requesting to transmit a control information relating to the user terminal;
a control receiving unit configured to be waiting to receive an information at least including the control information from the user terminal after receiving the request from the host unit; and
a transmitting unit configured to transmit the response to the host unit after the control receiving unit receives the information from the user terminal.

9. The communication control system according to claim 8, wherein
the communication apparatus further includes a timer that generates a trigger at a predetermined time interval after the request receiving unit received the request, wherein the transmitting unit transmits a predetermined information that does not include information on end of transmission of the response to response receiving unit of the host unit as the response to the request,
a time-out measuring unit configured to measure a time from the request receiving unit receiving the request to the request receiving unit receiving time-out information indicating that there is no response to the request, and
an interval calculating unit configured to calculate, based on the time measured by the time-out measuring unit, a time interval at which the timer generates the trigger, wherein the timer generates the trigger at the time interval calculated by the interval calculating unit.

10. The communication control system according to claim 9, wherein
upon the control receiving unit receiving the control information, the transmitting unit transmits the control information with the information on end of transmission of the response to the request to the host unit, and
upon the response receiving unit receiving the response to the request that includes the information on end of transmission of the response to the request.

11. The communication control system according to claim 9, wherein the interval calculating unit sets the time interval shorter than the time that is measured by the time-out measuring unit.

12. The communication control system according to claim 8, wherein
the control information input to the control inputting unit includes information indicating a control of an electric appliance, and
the host unit further includes a controller that controls the electric appliance based on the information included in the control information that is received by the response receiving unit as a response to the request.

13. The communication control system according to claim 8, wherein
the host unit is an electric appliance, and
the transmitting unit transmits the control information including information indicating a control of the electric appliance as the response to the request.

14. A method of communication that is employed in a communication control system, the communication control system including a user terminal, a communication apparatus, and a host unit, the method comprising:
the communication apparatus receiving a request from the host unit, each request requesting to transmit a control information relating to the user terminal;
the communication apparatus waiting to receive a information from a user terminal, the information including at least the control information to be transferred to the host unit; and
the communication apparatus transmitting the control information to the host unit as a response to the request after receiving the request.

15. A computer program that is employed in a communication control system, the communication control system including a user terminal, a communication apparatus, and a host unit, the computer program making the communication apparatus execute:
receiving a request from the host unit, each request requesting to transmit a control information relating to the user terminal;
waiting to receive a information from a user terminal, the information including at least a control information to be transferred to the host unit; and
transmitting the control information to the host unit as a response to the request after receiving the request.
